(19) United States
(12) Patent Application Publication
(10) Pub. No.: US 2025/0338017 A1
(43) Pub. Date: Oct. 30, 2025

(54) IMAGING DEVICE AND IMAGE BLUR CORRECTION MECHANISM HAVING HEAT-DISSIPATING STRUCTURE

(71) Applicant: CANON KABUSHIKI KAISHA, Tokyo (JP)

(72) Inventor: MOMOE KATSUMATA, Tokyo (JP)

(21) Appl. No.: 19/259,224

(22) Filed: Jul. 3, 2025

Related U.S. Application Data
(63) Continuation of application No. PCT/JP2023/047194, filed on Dec. 28, 2023.

(30) Foreign Application Priority Data
Jan. 25, 2023 (JP) 2023-009399

(51) Int. Cl. H04N 23/68; H04N 23/52

(52) U.S. Cl. CPC H04N 23/687; H04N 23/52

(57) ABSTRACT

An imaging device includes an imaging unit provided with an image blur correction mechanism. The image blur correction mechanism includes a movable portion that holds an image sensor, a support portion that supports the movable portion to be movable in a direction perpendicular to the imaging optical axis, and a heat-dissipating member that connects the movable portion and the support portion. The heat-dissipating member includes a connection portion that connects the movable portion and the support portion, a movable portion attachment region attached to the movable portion, and a support portion attachment region attached to the support portion. The movable portion attachment region and the support portion attachment region are arranged to overlap each other in the direction of the imaging optical axis. The connection portion includes a plurality of bent portions and slits extending parallel to the direction in which the movable portion and the support portion are connected.

### CROSS-REFERENCE TO RELATED APPLICATIONS

This application is a Continuation of International Patent Application No. PCT/JP2023/047194, filed Dec. 28, 2023, which claims the benefit of Japanese Patent Application No. 2023-009399, filed Jan. 25, 2023, both of which are hereby incorporated by reference herein in their entirety.

### BACKGROUND

### Field of the Technology

The present disclosure relates to an image blur correction mechanism and an imaging device. More particularly, the present disclosure pertains to an image blur correction mechanism having a heat-dissipating structure and an imaging device including an image sensor provided with the image blur correction mechanism.

### Description of the Related Art

Imaging devices, including digital still cameras and video cameras, are equipped with an image sensor, such as a CMOS sensor, for capturing images of a subject, as well as electronic components, such as a CPU or an IC, mounted on a circuit board. The image sensor and the electronic components generate heat. If the temperatures of the image sensor and the electronic components rise excessively, their performance may degrade or they may malfunction, potentially resulting in a failure to achieve high-quality imaging.

In recent years, it has become common for imaging devices to have an image blur correction mechanism configured to move the image sensor in a direction perpendicular to the optical axis to correct image blur and thereby improve image quality. In such imaging devices that perform image blur correction, heat is generated from the image sensor during operation of the image blur correction mechanism, continuous shooting, or video recording. This heat may affect image quality, and thus, sufficient heat dissipation is required.

For example, PCT International Publication No. WO2020/202811 discloses a technique for reducing the load applied to the image blur correction mechanism by orienting the thickness direction of a flexible heat transfer member, which connects a movable portion and a fixed portion of the image blur correction mechanism, along a direction perpendicular to the optical axis.

For another example, Japanese Patent Application Laid-Open No. 2021-189225 discloses a technique for improving controllability by defining a transit position through which a movable portion passes during operation of the image blur correction mechanism to reduce the load on a heat transfer member caused by the movement of the movable portion.

However, in the conventional technique disclosed in PCT International Publication No. WO2020/202811, since the thickness direction of the heat transfer member is oriented perpendicular to the optical axis, improving heat dissipation requires either increasing the number of heat transfer members or increasing the width of the heat transfer member. This results in an increased load on the image blur correction mechanism or an increase in the overall size of the image blur correction mechanism.

In addition, the conventional technique disclosed in Japanese Patent Application Laid-Open No. 2021-189225 involves defining a transit position for the movable portion, which results in poor responsiveness of the image blur correction mechanism.

### SUMMARY

Embodiments described herein are directed to an imaging device and an image blur correction mechanism having a heat-dissipating structure capable of sufficiently dissipating heat generated from an image sensor without increasing the overall size and without interfering with the drive control of a movable portion.

In one embodiment, an image blur correction mechanism includes a movable portion, a support portion, and a heat-dissipating sheet. The movable portion is configured to hold an image sensor. The support portion is configured to support the movable portion to be movable in a first direction perpendicular to an optical axis direction of an imaging optical system and in a second direction perpendicular to both the optical axis direction and the first direction. The heat-dissipating sheet does not include a signal line and thermally connects the movable portion and the support portion. The heat-dissipating sheet includes a connection portion that thermally connects the movable portion and the support portion, a movable portion attachment region where the heat-dissipating sheet is attached to the movable portion, and a support portion attachment region where the heat-dissipating sheet is attached to the support portion. The movable portion attachment region and the support portion attachment region are arranged to overlap each other when viewed along the optical axis direction. The connection portion is bent and includes a bent portion along the first direction, and the bent portion includes one or more slit portions arranged in the second direction.

Features of the present disclosure will become apparent from the following description of embodiments with reference to the attached drawings.

### BRIEF DESCRIPTION OF THE DRAWINGS

FIG. 1 is a block diagram illustrating an example of the internal configuration of a digital camera as an imaging device according to an embodiment.

FIG. 2 is a rear exploded perspective view of the digital camera.

FIG. 3A is an exploded perspective view of an imaging unit in FIG. 2 and an image blur correction mechanism therein.

FIG. 3B is an exploded perspective view of an imaging unit in FIG. 2 and an image blur correction mechanism therein.

FIG. 4 is a detailed view of area A around a heat-dissipating member illustrated in FIG. 2 provided in an image blur correction mechanism according to a first embodiment.

FIG. 5 is a cross-sectional view of vicinity A of the heat-dissipating member illustrated in FIG. 4.

FIG. 6A is a developed view of the heat-dissipating member.

FIG. 6B is a developed view of the heat-dissipating member.

FIG. 6C is a developed view of the heat-dissipating member.

FIG. 7 is a detailed view of area A around a heat-dissipating member illustrated in FIG. 2 provided in an image blur correction mechanism according to a second embodiment.

FIG. 8 is a cross-sectional view of vicinity A of the heat-dissipating member illustrated in FIG. 7.

### DESCRIPTION OF THE EMBODIMENTS

Exemplary embodiments will be described in detail below with reference to the accompanying drawings.

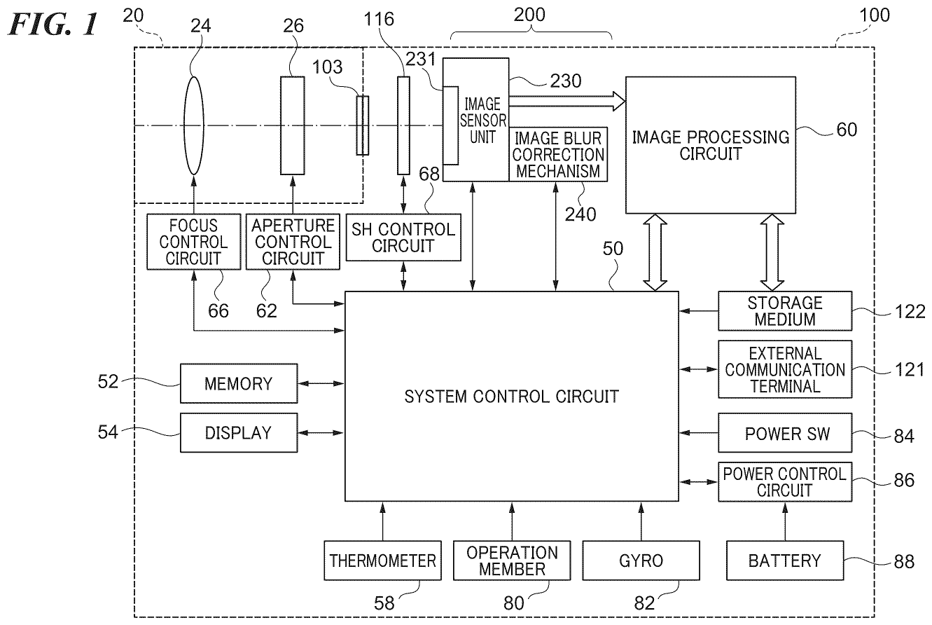

First, the internal configuration of a digital camera 100 as an imaging device according to an embodiment will be described with reference to FIG. 1.

FIG. 1 is a block diagram illustrating an example of the internal configuration of the digital camera 100.

The digital camera 100 is provided with a detachable lens unit 20, which includes an imaging lens 24 and an aperture 26. The digital camera 100 includes a shutter 116, an imaging unit 200, a gyroscope 82, a system control circuit 50, an image processing circuit 60, a memory 52, and a display 54. The digital camera 100 also includes an aperture control circuit 62, a focus control circuit 66, and a shutter (SH) control circuit 68. The digital camera 100 further includes a thermometer 58, operation members 80, a power switch (SW) 84, a power control circuit 86, a battery 88, and a storage medium 122.

The shutter 116 is a light-shielding member and is configured to open and close to control the amount of light to which an image sensor 231 (described later) in the imaging unit 200 is exposed.

A light beam incident on the imaging lens 24 is guided through the aperture 26 and the shutter 116, forming an optical image on the imaging surface of the image sensor 231.

The imaging unit 200 includes an image sensor unit 230 and an image blur correction mechanism 240. The image sensor 231 is located in the image sensor unit 230 and converts an optical image into an electrical signal.

The image blur correction mechanism 240 performs image sensor shift-type image blur correction; specifically, it corrects image blur by moving the image sensor 231 within a plane perpendicular to the optical axis of the imaging optical system (imaging optical axis) according to the amount of shake detected by the gyroscope 82.

The system control circuit 50 controls the overall operation of the digital camera 100. The memory 52 stores constants, variables, programs, and the like used for the operation of the system control circuit 50.

The system control circuit 50 functions as both a determination unit and a control unit in various operations of the digital camera 100. In addition, the system control circuit 50 controls the shutter 116, the imaging lens 24, and the aperture 26 through the shutter control circuit 68, the focus control circuit 66, and the aperture control circuit 62 based on calculation results obtained by the image processing circuit 60 from image data captured by the image sensor 231, thereby performing autofocus (AF) processing and auto exposure (AE) processing. The memory 52 also stores the holding state of the image sensor unit 230 as maintained by the image blur correction mechanism 240.

The display 54 includes a rear display 175, an electronic viewfinder (EVF) display 176, and the like, and displays information related to shooting.

The thermometer 58 measures the temperatures of the image sensor 231 and other heat-generating components.

The operation members 80 include various buttons, switches, and the like. The operation members 80 are used to select functions, make settings, and issue instructions related to operations such as shooting, playback, and communication.

The gyroscope 82 detects shake of the digital camera 100, which leads to image blur.

The power switch 84 allows the power of the digital camera 100 to be switched on and off.

The power control circuit 86 includes a battery detection circuit, a DC/DC converter, and a switch circuit that switches the blocks to which power is supplied. The power control circuit 86 detects the type and remaining capacity of the battery 88, which serves as a power source for the digital camera 100, and supplies the required voltage to each component, including the storage medium 122, for the necessary duration based on the detection result and instructions from the system control circuit 50.

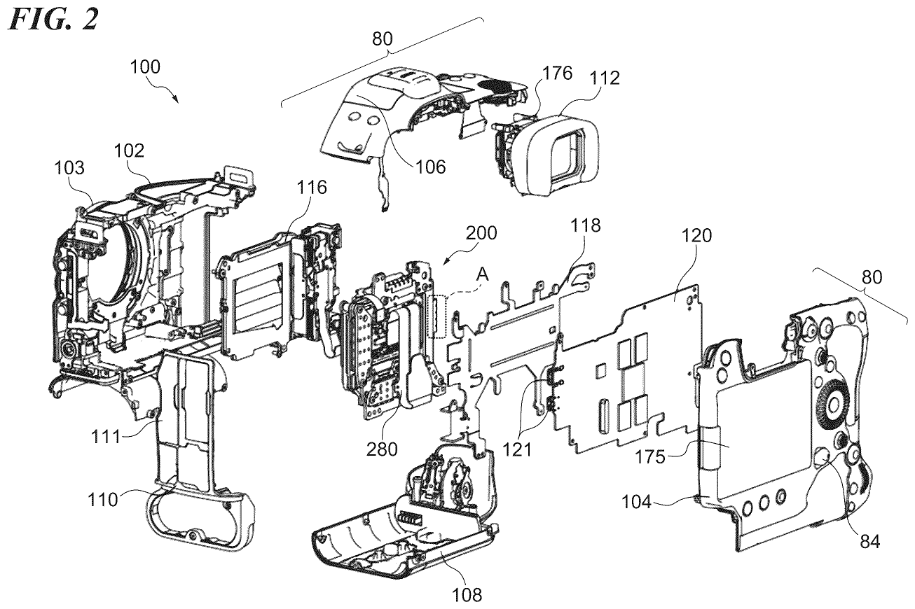

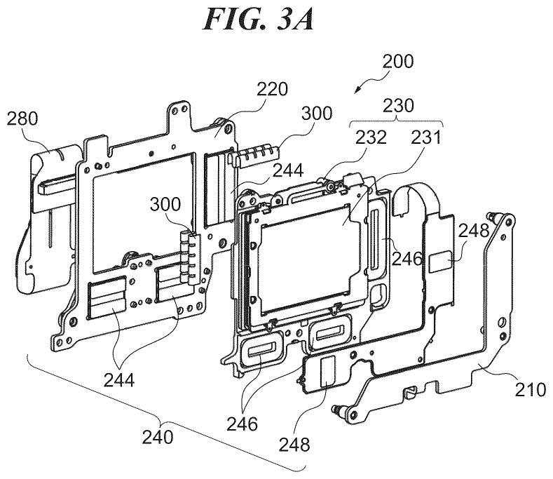

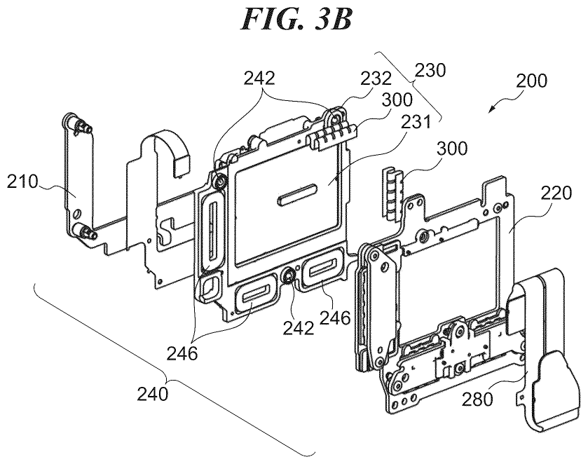

Next, the heat-dissipating structure of the image sensor 231 will be described with reference to FIGS. 2 to 3B.

FIG. 2 is a rear exploded perspective view of the digital camera 100.

The digital camera 100 includes a front base 102, a rear cover 104, a top cover 106, a bottom cover 108, and a side cover 110 as its exterior components.

The front base 102 is formed of magnesium die-cast material or resin. The front base 102 includes a mount 103 and a grip portion. The mount 103 is fixed to the front base 102, enabling the attachment of the lens unit 20. The grip portion is used to hold the digital camera 100.

Some of the operation members 80 are arranged on the rear cover 104. The rear display 175 is mounted on the rear cover 104 and is capable of opening and closing. In addition, the EVF display 176 and a viewfinder unit 112 for user observation are also mounted on the rear cover 104.

Some of the operation members 80 are also arranged on the top cover 106. The bottom cover 108 has a battery compartment for housing the battery 88, as well as a tripod mount attached thereto for securing the digital camera 100.

The side cover 110 is provided with a terminal cover 111 to protect an external communication terminal 121.

The imaging unit 200, a printed circuit board 120, the shutter 116, and a chassis 118 are arranged inside these exterior components. Various electronic components are mounted on the printed circuit board 120, including electronic devices incorporating the system control circuit 50 and the image processing circuit 60, as well as a connector for attaching the storage medium 122. The printed circuit board 120 is fixed with screws to the front base 102 and the metal chassis 118. The external communication terminal 121 is also mounted on the printed circuit board 120.

The image sensor unit 230 is connected to the printed circuit board 120 via a flexible circuit board 280, and an image signal from the image sensor 231 is transmitted to the printed circuit board 120 through the flexible circuit board 280.

Since the image sensor 231 consumes a relatively large amount of power among the components of the digital camera 100, its temperature tends to increase. If the temperature of the image sensor 231 exceeds a predetermined level, captured images may be adversely affected. Therefore, it is necessary to maintain the temperature of the image sensor 231 at or below the predetermined level. For this purpose, the imaging unit 200, which includes the image sensor 231, is fixed to the front base 102 with screws and is configured such that heat from the imaging unit 200 is transferred to the front base 102.

Next, the image blur correction mechanism 240 in the imaging unit 200 will be described with reference to FIGS. 3A and 3B.

FIG. 3A is a front exploded perspective view of the imaging unit 200 and the image blur correction mechanism 240 therein. FIG. 3B is a rear exploded perspective view of the imaging unit 200 and the image blur correction mechanism 240 therein.

The imaging unit 200 includes a front-side plate 210 and a rear-side plate 220, and the image sensor unit 230 is located between them. The front-side plate 210 and the rear-side plate 220 are metal plates. The rear-side plate 220 is fastened to the front base 102 with screws and is fixed to the front-side plate 210 with the image sensor unit 230 interposed therebetween.

The image sensor unit 230 includes the image sensor 231 and an image sensor holder 232 (movable portion) configured to hold the image sensor 231. Three balls 242 are arranged between the image sensor holder 232 and the rear-side plate 220, positioned around the image sensor 231 so as to surround the optical axis of the imaging optical system (imaging optical axis). The free rotation of the balls 242 allows the image sensor unit 230 to be swingably held between the front-side plate 210 and the rear-side plate 220 in a plane perpendicular to the imaging optical axis (in two directions: the X-axis direction and the Y-axis direction). Here, the X-axis direction (first direction) is a direction perpendicular to the imaging optical axis direction, and the Y-axis direction (second direction) is a direction perpendicular to both the imaging optical axis direction and the X-axis direction. In other words, the image blur correction mechanism 240 includes the rear-side plate 220 (support portion), which supports the image sensor holder 232 so as to be movable in a plane perpendicular to the imaging optical axis (in two directions: the X-axis direction and the Y-axis direction), and the balls 242. In addition, the image blur correction mechanism 240 is provided with a heat-dissipating member 300.

A plurality of magnets 244 are arranged on the rear-side plate 220, and a plurality of coils 246 are arranged on the image sensor holder 232 so as to face the magnets 244.

The coils 246 generate magnetic fields when supplied with power through the flexible circuit board 280. The swinging motion of the image sensor unit 230 is controlled by utilizing repulsive and attractive forces between the magnetic fields generated by the coils 246 and the magnets 244. In general, under the control of the image blur correction mechanism 240, the image sensor unit 230 is maintained at an imaging center position and is also moved in a direction that compensates for image blur or shake of the digital camera 100 caused by the photographer.

Metal plates 248 are provided in front of the coils 246, and the magnets 244 attract the metal plates 248, thereby bringing the image sensor holder 232, the rear-side plate 220, and the balls 242 into mutual contact. With this configuration, the flange focal distance from the lens mount to the image sensor 231 is set to a predetermined value in the digital camera 100.

The heat-dissipating member 300 is made of a graphite sheet laminated with a PET sheet or the like and connects the image sensor holder 232 to the rear-side plate 220. Heat generated in the image sensor 231 is transferred to the rear-side plate 220 through the image sensor holder 232, which holds the image sensor 231, and the heat-dissipating member 300. The heat is then further transferred to the front base 102, to which the rear-side plate 220 is fastened with screws. Note that the heat-dissipating member 300 does not transmit signals or information between the image sensor holder 232 (the image sensor 231) and the rear-side plate 220 (i.e., the heat-dissipating member 300 does not include signal lines).

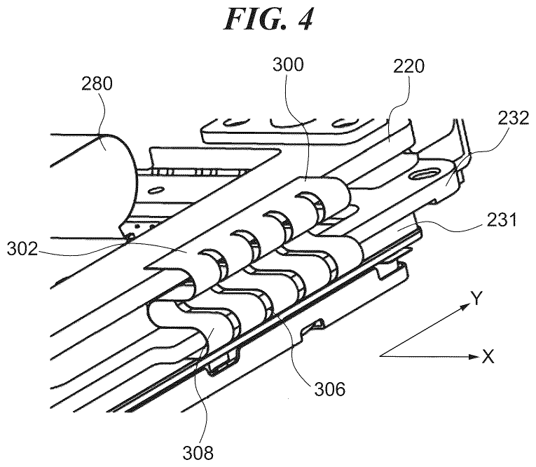

With reference to FIGS. 4 to 6C, a description will be given of the shape of the heat-dissipating member 300 provided in the image blur correction mechanism 240 according to the first embodiment.

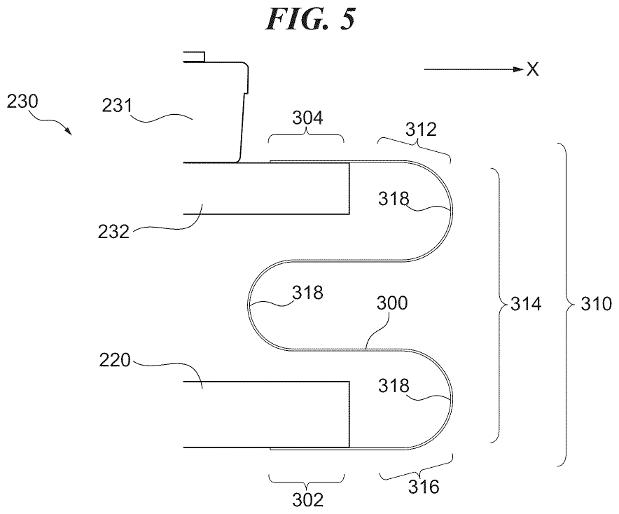

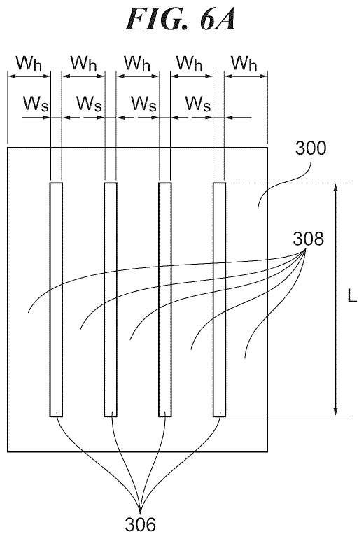

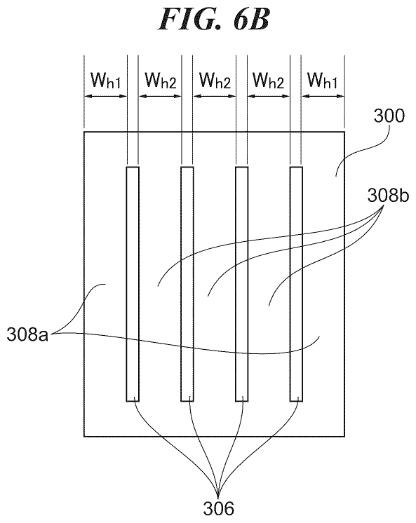

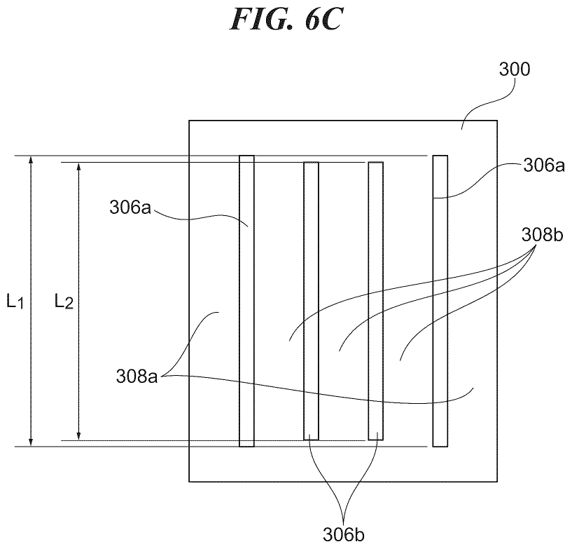

FIG. 4 is a detailed view of area A around the heat-dissipating member 300 illustrated in FIG. 2 according to the first embodiment. FIG. 5 is a cross-sectional view of area A around the heat-dissipating member 300 illustrated in FIG. 4. FIGS. 6A to 6C are developed views of the heat-dissipating member 300. In FIGS. 4 and 5, the X-axis direction (first direction) and the Y-axis direction (second direction) are indicated by arrows. In the developed views of the heat-dissipating member 300, slits 306 (described later) are illustrated as extending in the X-axis direction. The Y-axis direction is a direction perpendicular to both the imaging optical axis direction and the X-axis direction.

The heat-dissipating member 300 includes a movable portion attachment region 304, a fixed portion attachment region 302 (support portion attachment region), and a connection portion 310. The heat-dissipating member 300 is attached to the image sensor holder 232 at the movable portion attachment region 304 and to the rear-side plate 220 at the fixed portion attachment region 302 using double-sided tape or the like. More specifically, the movable portion attachment region 304 is located on the side of the image sensor holder 232 that faces the front base 102 (i.e., on a surface closer to the image sensor 231 in the imaging optical axis direction). The fixed portion attachment region 302 is located on the side of the rear-side plate 220 that faces the rear cover 104 (i.e., on a surface farther from the image sensor 231 in the imaging optical axis direction). The movable portion attachment region 304 and the fixed portion attachment region 302 are arranged so as to overlap each other when viewed along the imaging optical axis direction.

The connection portion 310 includes a first connection portion 312, a second connection portion 314, and a third connection portion 316. The first connection portion 312 extends in the X-axis direction, specifically outward from the image sensor unit 230, from the movable portion attachment region 304. Similarly, the third connection portion 316 extends in the X-axis direction, specifically outward from the image sensor unit 230, from the fixed portion attachment region 302. In other words, the first connection portion 312 and the third connection portion 316 extend in the X-axis direction away from the image sensor 231. In contrast, the central portion of the second connection portion 314, which is located between the first connection portion 312 and the third connection portion 316, extends in the X-axis direction toward the image sensor 231 and is positioned between the image sensor holder 232 and the rear-side plate 220. That is, the heat-dissipating member 300 (the connection portion 310) is bent and includes three bent portions 318 along its length in the X-axis direction (first direction).

The connection portion 310 includes at least one slit 306 to reduce the load associated with the swinging motion of the image sensor unit 230. The slits 306 extend in the X-axis direction and are arranged side by side in the Y-axis direction in the figures. Specifically, the connection portion 310 is formed by connecting, in this order from a side where the image sensor holder 232 is located, the first connection portion 312, the second connection portion 314, and the third connection portion 316, and extends parallel to the direction of this connection. The slits 306 are arranged side by side in a direction perpendicular to the direction in which they extend. That is, the bent portions 318 each include one or more slits 306 arranged in the Y-axis direction. The regions of the connection portion 310 other than the slits 306 are heat transfer portions 308 filled with a graphite sheet or the like. In other words, in the bent portions 318, the heat transfer portions 308 and the slits 306 are alternately arranged in the Y-axis direction. The width of each slit 306 (in the Y-axis direction) is set such that, even when the image sensor unit 230 undergoes maximum displacement, an adjacent pair of the heat transfer portions 308 (the heat transfer portions 308 that face each other across a slit) do not come into contact with each other. In this manner, the generation of load due to contact between the heat transfer portions 308 is suppressed.

In FIG. 5, the second connection portion 314 has a length at least twice as long as each of the first connection portion 312 and the third connection portion 316. The length of the second connection portion 314 is designed to be greater than half of the maximum displacement amount of the image sensor holder 232 in the X-axis direction, which is parallel to the direction in which the slits 306 extend (see FIG. 4). As a result, even when the image sensor unit 230 is displaced to the maximum extent in the X-axis direction, the second connection portion 314 can be prevented from fully coming out from between the image sensor holder 232 and the rear-side plate 220.

FIG. 6A is a developed view of the heat-dissipating member 300. All of the slits 306 have the same length L (in the X-axis direction). In addition, all of the slits 306 have the same width Ws, and all of the heat transfer portions 308 also have the same width Wh. In this manner, by ensuring that all of the slits 306 have the same width and that the heat transfer portions 308 likewise have the same width, the load applied according to the position (displacement) of the image sensor unit 230 exhibits hysteresis behavior, which facilitates control when the image blur correction mechanism 240 is in operation.

FIG. 6B is a developed view of the heat-dissipating member 300, illustrating an example in which outermost heat transfer portions 308a have a width Wh1 greater than the width Wh2 of other heat transfer portions 308b. When the image sensor unit 230 is swung in the roll direction by the image blur correction mechanism 240, a load is applied to the heat transfer portions located farthest from the imaging optical axis (i.e., the outermost heat transfer portions 308a), making them more prone to damage. In addition, when the digital camera 100 is turned off, no power is supplied to the image blur correction mechanism 240. In this state, the image sensor unit 230 can move freely between the front-side plate 210 and the rear-side plate 220, which may cause damage to the heat-dissipating member 300. However, if the widths of all the heat transfer portions 308 are increased, the load applied by the heat-dissipating member 300 during operation of the image blur correction mechanism 240 also increases. Therefore, in the modified example illustrated in FIG. 6B, only the outermost heat transfer portions 308a, which are most likely to be subjected to a load, are formed with an increased width, and the movable range of the outermost heat transfer portions 308a is designed to be larger than that of the other heat transfer portions 308b.

FIG. 6C is a developed view of the heat-dissipating member 300, illustrating an example in which outermost slits 306a have a length L1 greater than the length L2 of other slits 306b. As described above, when the image sensor unit 230 is swung in the roll direction, the heat transfer portions located farthest from the imaging optical axis (i.e., the outermost heat transfer portions 308a) are more prone to damage. However, increasing the overall length of the heat-dissipating member 300 would require more space, which could restrict its placement or lead to an increase in the size of the imaging unit 200. Furthermore, if the lengths of all the slits 306 are increased, the movable range of all the heat transfer portions 308 also increases, thus increasing the likelihood of contact between adjacent heat transfer portions 308. Consequently, it becomes necessary to increase the width Wh of the slits 306, which in turn results in an increase in the overall size of the heat-dissipating member 300. Therefore, in the modified example illustrated in FIG. 6C, the outermost slits 306a, which are located farthest from the imaging optical axis and adjacent to the outermost heat transfer portions 308a that are prone to damage, are designed to be longer than the other slits 306b. As a result, the movable range of the outermost heat transfer portions 308a becomes larger than that of the other heat transfer portions 308b, thereby preventing damage to the outermost heat transfer portions 308a. At the same time, by providing the outermost slits 306a with a width greater than that of the other slits 306b, it is possible to prevent contact between adjacent heat transfer portions even when the movable range of the outermost heat transfer portions 308a is increased.

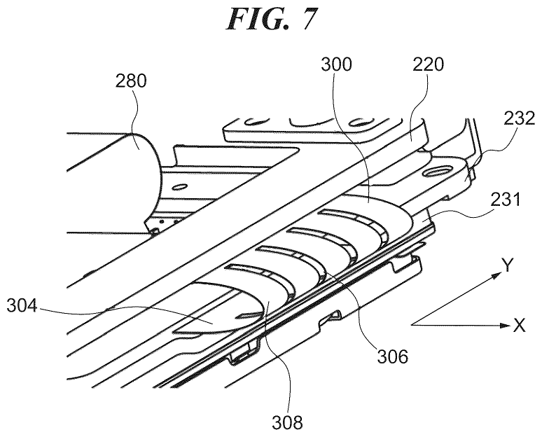

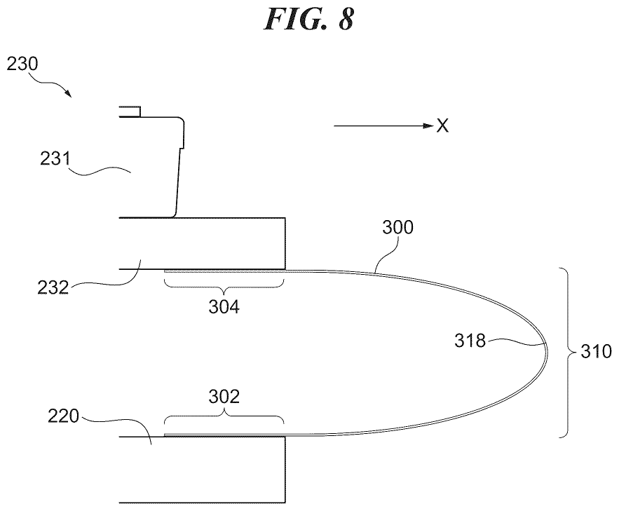

The shape of the heat-dissipating member 300 provided in the image blur correction mechanism 240 according to a second embodiment will be described with reference to FIGS. 7 and 8. In the following description, like reference numerals are used to designate components that are identical or correspond to those in the first embodiment.

FIG. 7 is a detailed view of area A around the heat-dissipating member 300 illustrated in FIG. 2 according to the second embodiment. FIG. 8 is a cross-sectional view of area A around the heat-dissipating member 300 illustrated in FIG. 7.

The heat-dissipating member 300 is attached to the image sensor holder 232 at the movable portion attachment region 304 and to the rear-side plate 220 at the fixed portion attachment region 302 using double-sided tape or the like. More specifically, the movable portion attachment region 304 is located on the side of the image sensor holder 232 that faces the rear cover 104 (i.e., on a surface farther from the image sensor 231 in the imaging optical axis direction). The fixed portion attachment region 302 is located on the side of the rear-side plate 220 that faces the front base 102 (i.e., on a surface closer to the image sensor 231 in the imaging optical axis direction).

The connection portion 310 extends outward from the image sensor unit 230, from both the movable portion attachment region 304 and the fixed portion attachment region 302. In other words, the connection portion 310 extends in the X-axis direction away from the image sensor 231.

In this embodiment, the heat-dissipating member 300 extends further outward from the image sensor unit 230 than in the first embodiment, which results in an increase in the overall size of the image sensor unit 230. However, since the heat-dissipating member 300 has only one bent portion 318, its reaction force is smaller, thereby reducing the load applied to the heat-dissipating member 300 during the swinging motion of the image sensor unit 230.

According to the above embodiments, it is possible to provide an imaging device and an image blur correction mechanism having a heat-dissipating structure capable of sufficiently dissipating heat generated from an image sensor without increasing the overall size and without interfering with the drive control of a movable portion.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image blur correction mechanism, comprising:
a movable portion configured to hold an image sensor;
a support portion configured to support the movable portion to be movable in a first direction perpendicular to an optical axis direction of an imaging optical system and in a second direction perpendicular to both the optical axis direction and the first direction; and
a heat-dissipating sheet that does not include a signal line and thermally connects the movable portion and the support portion, wherein
the heat-dissipating sheet includes a connection portion that thermally connects the movable portion and the support portion, a movable portion attachment region where the heat-dissipating sheet is attached to the movable portion, and a support portion attachment region where the heat-dissipating sheet is attached to the support portion;
the movable portion attachment region and the support portion attachment region are arranged to overlap each other when viewed along the optical axis direction;
the connection portion is bent and includes a bent portion along the first direction; and
the bent portion includes one or more slit portions arranged in the second direction.

2. The image blur correction mechanism according to claim 1, wherein the one or more slit portions have a width in the second direction such that, even when the movable portion undergoes maximum displacement, heat transfer portions that face each other across any of the one or more slit portions do not come into contact with each other.

3. The image blur correction mechanism according to claim 2, wherein
all of the slit portions have a uniform width in the second direction and a uniform length in the first direction; and
all of the heat transfer portions have a uniform width in the second direction.

4. The image blur correction mechanism according to claim 2, wherein
the heat transfer portions include an outermost heat transfer portion located farthest from the optical axis; and
the outermost heat transfer portion has a width in the second direction greater than that of another heat transfer portion.

5. The image blur correction mechanism according to claim 2, wherein
the slit portions include an outermost slit portion located farthest from the optical axis; and
the outermost slit portion has a length in the first direction greater than that of another slit portion.

6. The image blur correction mechanism according to claim 5, wherein the outermost slit portion has a width in the second direction greater than that of the other slit portion.

7. The image blur correction mechanism according to claim 1, wherein
the connection portion includes a first connection portion, a second connection portion, and a third connection portion, which are arranged in order from a side where the movable portion is located;
the first connection portion and the third connection portion extend in the first direction away from the image sensor; and
a central portion of the second connection portion extends in the first direction toward the image sensor to be positioned between the movable portion and the support portion.

8. The image blur correction mechanism according to claim 7, wherein
the second connection portion has a length at least twice as long as each of the first connection portion and the third connection portion; and
the length of the second connection portion is greater than half of a maximum displacement amount of the movable portion in the second direction.

9. The image blur correction mechanism according to claim 7, wherein
the movable portion attachment region is located on a surface of the movable portion that is closer to the image sensor in the optical axis direction; and
the support portion attachment region is located on a surface of the support portion that is farther from the image sensor in the optical axis direction.

10. The image blur correction mechanism according to claim 1, wherein the connection portion extends in the first direction away from the image sensor from both the movable portion attachment region and the support portion attachment region.

11. The image blur correction mechanism according to claim 10, wherein
the movable portion attachment region is located on a surface of the movable portion that is farther from the image sensor in an optical axis direction; and
the support portion attachment region is located on a surface of the support portion that is closer to the image sensor in the optical axis direction.

12. The image blur correction mechanism according to claim 1, wherein the heat-dissipating sheet is a graphite sheet.

13. The image blur correction mechanism according to claim 1, wherein
the bent portion further includes heat transfer portions; and
the slit portions and the heat transfer portions are alternately arranged in the second direction.

14. An imaging device comprising the image blur correction mechanism according to claim 1.
